(19) United States
(12) Patent Application Publication
(10) Pub. No.: US 2010/0106685 A1
(43) Pub. Date: Apr. 29, 2010

(54) METHOD AND SYSTEM FOR DATA SYNCHRONIZATION

(75) Inventors: Jonathan Stephen OTT, Houston, TX (US); Jonathan Michael Hale, Swansea (GB); Ross W. Dickerson, Fort Collins, CO (US); Kurke E. Bakow, Meridian, ID (US); Jeremy K. G. Pack, Caine (GB)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L. P.

(21) Appl. No.: 12/260,567

(22) Filed: Oct. 29, 2008

(51) Int. Cl. G06F 17/00; G06F 7/00

(52) U.S. Cl. 707/611; 707/E17.005; 707/640

(57) ABSTRACT

The present invention relates to data backup, and specifically to an apparatus, method, and computer readable medium to manage and automate the backup and synchronization of data on client machines and servers. For example, the system includes a user computer that contains local files and a data repository to which those local files are backed up and synchronized. A user is able to monitor and control the synchronization of the files. The files on the user computer are initially accessed. The files stored in the data repository can be utilized to update the local files, if necessary.

### FIELD OF THE INVENTION

The present invention relates to data backup, and specifically to an apparatus, method, and computer readable medium to manage and automate the backup and synchronization of data on client machines and servers.

### BACKGROUND OF THE INVENTION

The backup and synchronization of data stored on client machines is an important part of data management for companies and corporate enterprises. Large quantities of data are often stored locally on client PCs for local access. Ensuring that this data is backed up and synchronized at a central site ensures proper and efficient data management. Because of the roaming nature of mobile PCs and cost of infrastructure, backup or synchronization to a central site can be overlooked or become more complicated. The invention as disclosed herein provides a method to provide backup and synchronization of data on client PCs and data repositories at a central site.

### SUMMARY OF THE INVENTION

A first embodiment of the invention relates to a system for synchronizing data, comprising a user computer configured with a memory that contains at least one local file, a data repository, a synchronization component which backs up the at least one local file from the memory to the data repository, a monitoring component to monitor the synchronization of the at least one local file, wherein the user computer is configured to initially access the at least one local file from the user computer, and wherein a file in the data repository that corresponds to the at least one local file can be utilized to update the local file.

A second embodiment of the invention relates to a method for synchronizing backup data, comprising the steps of maintaining at least one local file on a user computer, synchronizing electronically the at least one local file on the user computer in a data repository, monitoring, by the user, the synchronization of the at least one local file, wherein the user computer is configured to initially access the at least one local file from the user computer, and wherein a file in the data repository that corresponds to the at least one local file can be utilized to update the local file.

A third embodiment of the invention relates to a computer readable medium, having embodied thereon computer readable code which when executed, performs a method for synchronizing backup data, comprising the steps of maintaining at least one local file on the user computer, synchronizing the at least one local file on the user computer in a data repository, monitoring, by the user, the synchronization of the at least one local file, wherein the user computer is configured to initially access the at least one local file from the user computer, and wherein a file in the data repository that corresponds to the at least one local file can be utilized to update the local file.

### BRIEF DESCRIPTION OF THE DRAWINGS

The present invention will be understood more fully from the detailed description given here below and from the accompanying drawings of the preferred embodiment of the invention, which, however, should not be taken to be limitative to the invention, but are for explanation and understanding only.

FIG. 1 is a schematic diagram of an exemplary computer network.

FIG. 2 is a schematic diagram depicting one embodiment of the invention.

FIG. 3 is a flow chart depicting one embodiment of the invention.

FIG. 4 is an example screen depicting one embodiment of the invention.

FIG. 5 is an example screen depicting one embodiment of the invention.

FIG. 6 is an example screen depicting one embodiment of the invention.

FIG. 7 is an example screen depicting one embodiment of the invention.

FIG. 8 is an example screen depicting one embodiment of the invention.

FIG. 9 is an example screen depicting one embodiment of the invention.

FIG. 10 is an example screen depicting one embodiment of the invention.

### DETAILED DESCRIPTION OF THE PREFERRED EMBODIMENTS

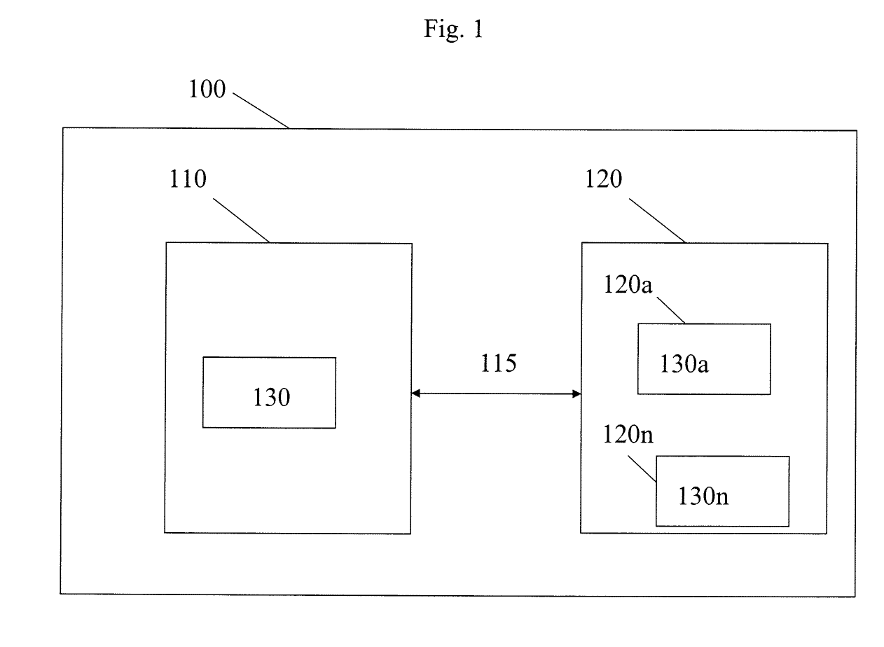

FIG. 1 depicts a computer network 100 with a local PC 110 that contains one or more local files and a data repository 120 to which the local files are backed up. Local PC 110 and data repository 120 are emblematic of a plurality of such PCs and repositories that could be contained in the network, or interspersed throughout a corporate network. For purposes of simplification, the relationship between one local PC 110 and one data repository 120 will be described herein. Further, the type of computer utilized as the local PC is not limiting on the invention. The data repository can also be embodied by a server, a data center containing a plurality of servers, a database, to name a few. The types or numbers of machines utilized as the data repository is not limiting on the invention. Arrow 115 depicts the relationship between the local PC 110 and the data repository 120, in which synchronization of the local files occurs. This relationship can be in the form of a physical link, a wireless connection, or other means well-known in the art. The type of relationship is not limiting on the invention. The relationship it utilizes to enable, for example, a local file 130 residing in the local PC 110 to have a corresponding backup file 130a that is stored in a network share 120a corresponding to the user a of the local PC in the data repository 120. The data repository can contain multiple network shares, 120a-n, corresponding to users a-n.

Synchronization occurs to ensure that the two files are equivalent. The initialization process for beginning synchronization is detailed further below. Synchronization enables files to be accessed from the local PC 110, or, if working remotely or for data recovery purposes for example, to be accessed from the data repository 120. The synchronization of local PC content with the data repository provides an ability to access the files from both locations without the added work of determining if the content matches. Thus, a replica of the files contained in the local PC 110 is also maintained at the data repository 120, with the files in synchronization with each other.

In one embodiment, a user that wants access to a file initially accesses the file from the local PC 110 as a local file 130. This provides a substantially seamless user experience, without causing a delay for the user by accessing the backup file 130a from the data repository 120. Local files, are used herein, represent individual files, top-level folders, sub-folders, and any other data or hierarchies of data that could be exist on a local PC. In one embodiment, the local file can be a file located in default user profile folders, such as the Documents folder, Desktop, Searches, to name a few. The default user profile folders listed are in no way exhaustive; rather, the invention provides for the backup and synchronization of many different types of files and folder. The local files can also include user profiles and local PC environment settings. In one embodiment, the local files include those relating to My Documents, Contacts, Desktop, Downloads, Favorites, Links, Music, Pictures, Saved Games and Searches.

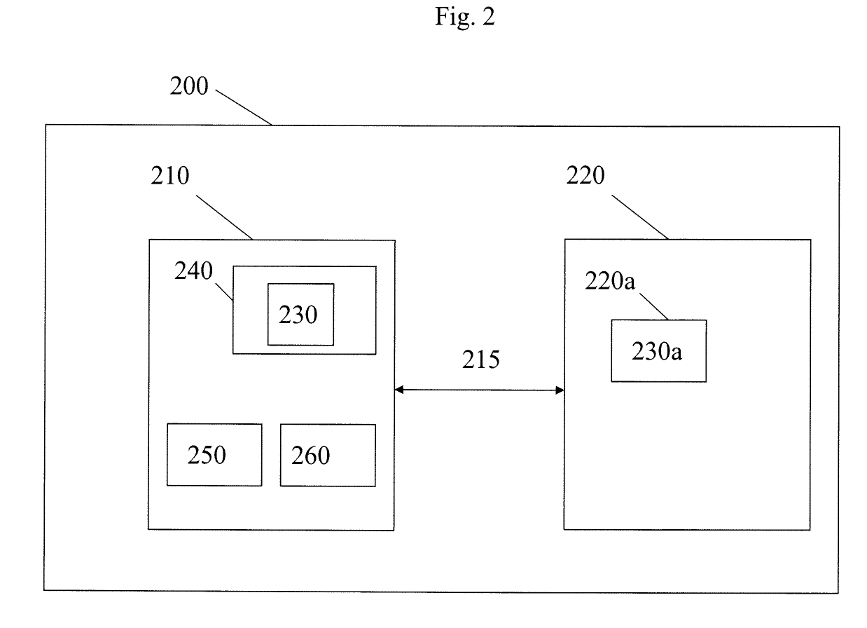

FIG. 2 shows one embodiment of the invention, in which a network 200 contains a data repository 220 and a local PC 210 that is configured with a memory 240 that contains at least one local file 230. The local PC 210 also contains a synchronization component 250 which backs up the local file from the memory 240 to the data repository 220 over the link 215. The data repository can include a network share 220a for the specific user, to store all of the files corresponding to that specific user. Local PC 210 also contains a monitoring component 260 that is utilized to monitor the synchronization of the at least one local file. When a user accesses a file on the local PC 210, the file is initially accessed from the local files 230 stored on the local PC 210. However, backup files 230a stored in the data repository can also be utilized to update the local file 230.

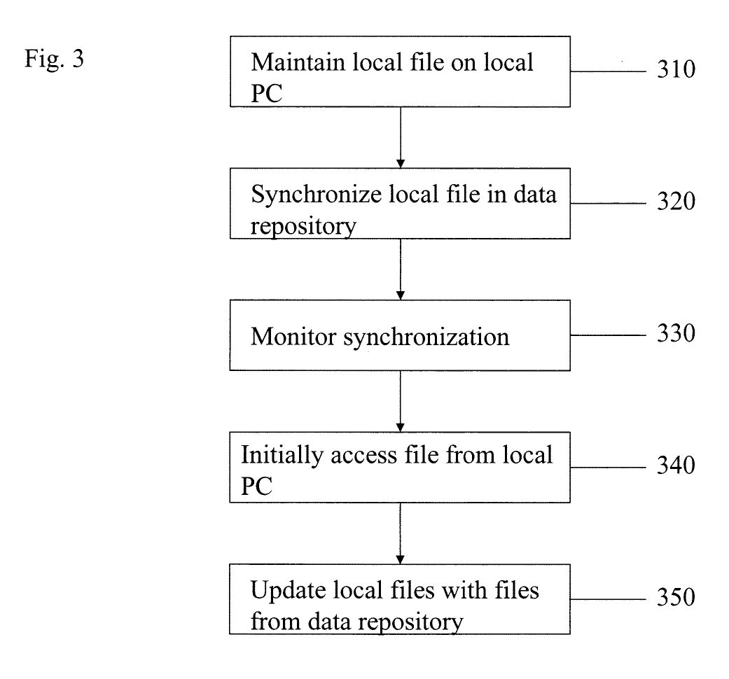

FIG. 3 shows an embodiment of the invention relating to a method of backing up and synchronizing data between the local PC 110 and the data repository 120. Specifically, at least one local file could be maintained on a user computer (step 310). This local file is then synchronized in a data repository (step 320). The user is able to monitor the synchronization of the local file (step 330). The user computer is configured to initially access the local file from the user computer (step 340). One or more backup files in the data repository that correspond to one or more local files in the user computer can be utilized to update those one or more local files (step 350).

In FIGS. 2 and 3, synchronization of the files are detailed, by backing up the content of the local files in the data repository, and being able to utilize the files of the data repository to update the local files. In one embodiment, when the local PC is connected to a network, and the link 115 is active, the local files are automatically backed up into the data repository. In one embodiment, when the local PC is offline, the local files are saved in a client side cache. When a synchronization of the local files is due to occur, files that are scheduled for backup are intercepted and saved to the client side cache. While the PC is offline, local files are read from, or written to, the client side cache as appropriate. In one embodiment, log files are kept each time synchronization occurs, to document the synchronization.

In one embodiment, the synchronization of each local PC 110 in the network is done on an individual basis. The local files stored on the local PC 110 are assumed to have the most updated content. Thus, for example, if the data repository does not have a backup file that corresponds to a specific local file on a local PC 110, the system will backup the specific local file so that its content is stored in the data repository. If the information in the local file and the data repository differ, conflict resolution can be initiated. Conflict resolution will be discussed in more detail below. In a further embodiment, a local file residing on one local PC will not affect a corresponding local file residing on a second local PC. In this embodiment, the data repository may store different backup files for the local files on each local PC. This was mentioned above, with respect to different network shares for different users' local files. This also prevents a situation where a deletion of a file on one local PC will cause the system to delete a corresponding file on other local PCs.

In one embodiment, the network shares are not full or near full. Users of the local PCs no longer keep personal files on legacy file shares. Rather, they store and synchronize their local files in their respective network shares 120a-n in the data repository. In one embodiment, each user maintains an individual file share on the data repository, where all of the content of the local files of the user are stored. In one embodiment, the local PC can support more than one user. Each user on the local PC has their own set of local files, and their own respective client side cache and network share on the data repository.

Further, the synchronization is not intrusive to a user working on the local PC. Rather, the synchronization occurs as a background process that runs as an application on the operating system. In some embodiments, the application utilizes a specialized background replication engine that runs on any standard or custom operating system. The specialized background replication engine may be constructed to address the requirements specific to the application that carries out the synchronization process. In some embodiments, synchronization is automatically scheduled, and may also be triggered by user or local system events. Further, the synchronization can occur across a variety of different links 115, including low-bandwidth links and high latency links. Utilizing synchronization as presented in this disclosure in some embodiments improves total cost of ownership and enables better data management.

In FIGS. 2 and 3, synchronization of the files are detailed, by backing up the content of the local files in the data repository, and being able to utilize the files of the data repository to update the local files. The method of synchronization utilized is not limiting on the invention. In one embodiment, the entire file is synchronized. In some embodiments, data that is in a compressed mode can be synchronized. In another embodiment, delta block synchronization is utilized. Delta block synchronization allows only changes in a document to be synchronized. This enables the amount of data transferred between the local PC 110 and the data repository 120 to be much smaller. Thus, delta block synchronization is a more efficient. In one embodiment, delta block synchronization utilizes Remote Differential Compression technology to determine the changed blocks of any given file, and then only synchronizes those blocks between the local PC 110 and the data repository 120. In one embodiment, Microsoft IntelliMirror™ can be utilized for synchronization.

In one embodiment, delta block synchronization is utilized when synchronizing PST files associated with Microsoft Outlook. PST files are personal stores created by Microsoft Outlook that are stored in the local PC 110. Using the Outlook Exchange connection, settings are stored on the Outlook server and synchronized independently of backing up data to a data repository. Messages that use more memory than that allotted to a user are saved in PST files on the user's local PC. In some embodiments, PST files are not stored in a location that would be synchronized. In these embodiments, the PST files are moved to a folder that would be synchronized to the data repository. Further, the default location to which PST files are saved would be changed to a folder that would be synchronized to the data repository. Thus, the PST files are synchronized along with the other files on the local PC. These files can be large, and thus are much more efficiently synchronized through delta block synchronization. Only the changes in the PST files are synchronized, thus reducing a lot of data transfer that would otherwise occur.

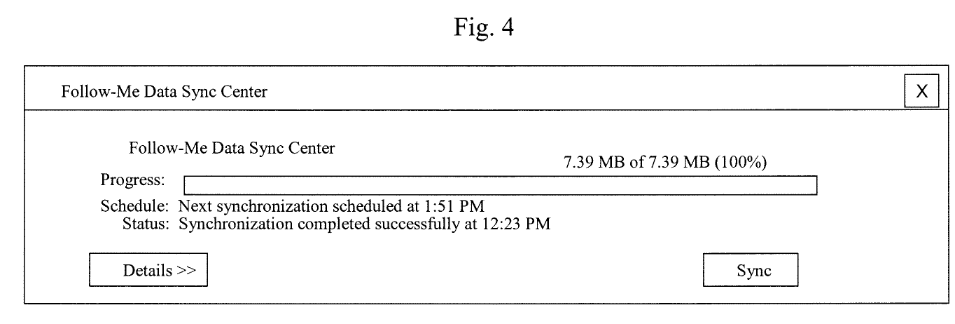

The synchronization can be monitored and/or controlled by a user of the local PC 110 or the data repository 120. A user interface is provided to enable a user to view the synchronizations that are scheduled or occurring, to schedule synchronizations, and to change the files that are scheduled for synchronization, to name a few. FIG. 4 depicts an example user interface that displays when the next synchronization is scheduled, and when the last synchronization was completed. It also allows the user to initiate a synchronization or obtain more details about the synchronization process.

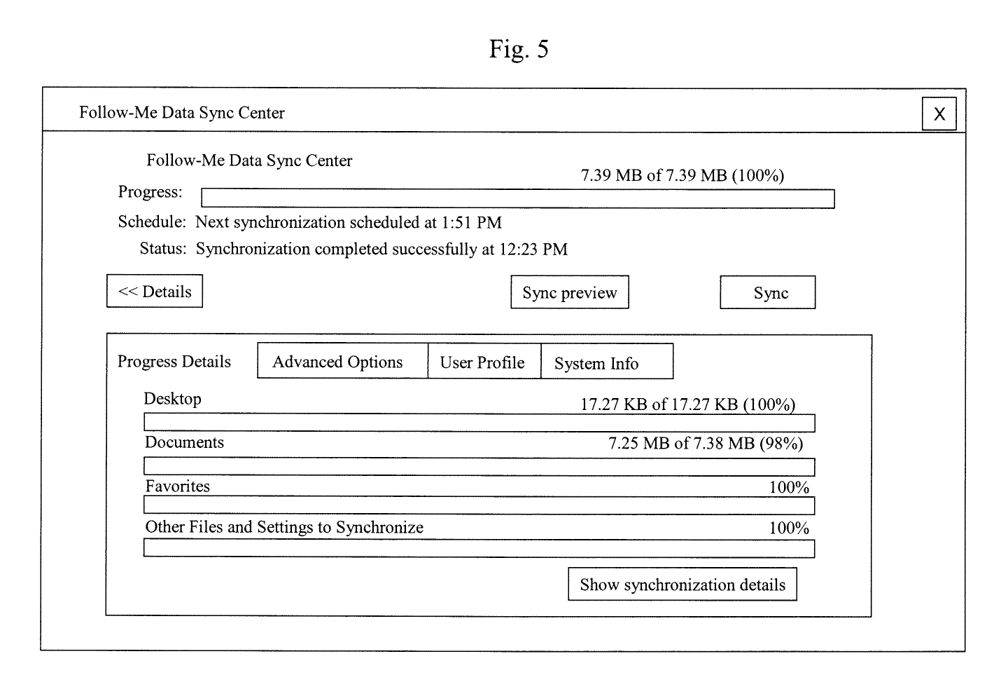

FIG. 5 depicts an example screen displaying scheduled and completed synchronizations. A user can see the progress and status of all of the folders that are being synchronized, and the amount of data synchronized with each folder as well as overall. In one embodiment, the user can change the amount of time between synchronizations, or set the synchronizations to begin at specific intervals. The user can also restore or set the synchronization intervals to predetermined intervals. Thus, the user is able to control the synchronization process or adjust the amount of time between automatic synchronizations of the data in the local PC and the data repository.

In one embodiment, from this screen, the user can choose to view advanced options. In one embodiment, the user can also choose to view their user profile. In one embodiment, the user can also choose to view System Information. The user may also be able to preview a synchronization, view details of the last synchronization, initiate a synchronization, or return to a menu with less options.

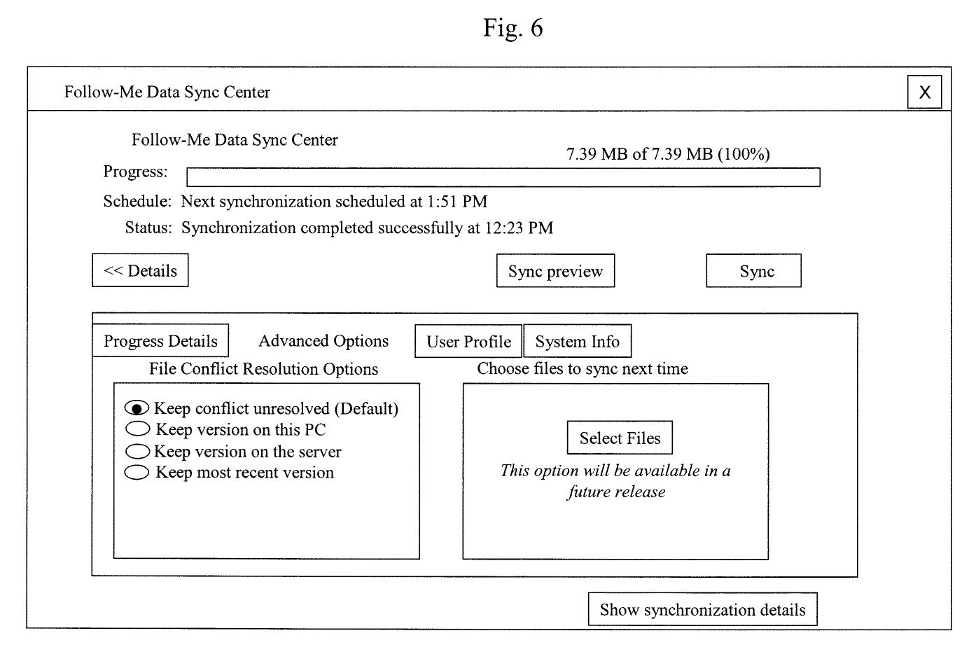

FIG. 6 depicts a screen that shows the advanced options available to the user. In one embodiment, these options include conflict resolution and viewing of files for future synchronization. The user is informed of which files have conflicts. A conflict occurs in one embodiment when a local file on two local PCs are each pointing to the same backup file in the data repository. This can occur, for example, by a user utilizing a file on his laptop, and then utilizing the same file on his desktop. Synchronization of one of the machines occurs before synchronization of the other, and a conflict arises when the second machine begins its synchronization process. In one embodiment, the user can choose to ignore the conflict, utilize the backup file in the data repository, utilize the local file on one of the local PCs, or keep the most recent version of the file in one of the local PCs or the data repository. In one embodiment, the synchronization of the file that has been marked with a conflict will not occur by default.

In one embodiment, the user is able to view in an electronic interface the files that are scheduled for synchronization. In one embodiment, the user is able to change the files that are pending for synchronization. In another embodiment, the user is able to modify the order in which files are synchronized. In one embodiment, synchronization is prioritized based on the modification date of the date. For example, data that has more recently been modified is prioritized to be synchronized first.

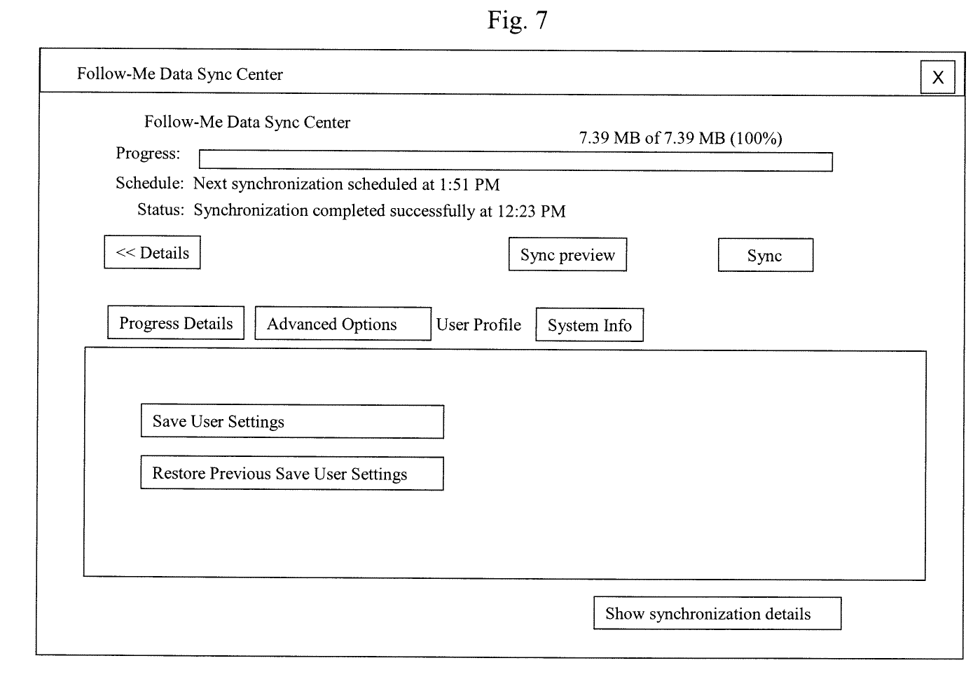

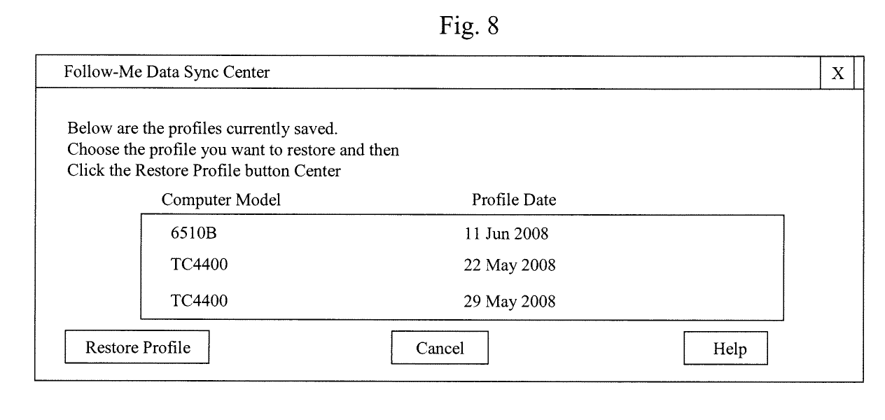

FIG. 7 depicts a screen that shows the user profile options available to the user. The user is able to save his or her settings, or restore previous user settings. FIG. 8 depicts a screen that shows options with regards to restoring previous user settings. In one embodiment, all previous user profiles that were saved are shown, along with the date the user profile was saved. In one embodiment, the user can save profiles from multiple PCs, and access them from any PC during a synchronization. In this embodiment, the path name of the PC is also displayed, to enable the user to understand from which PC the settings were originally saved.

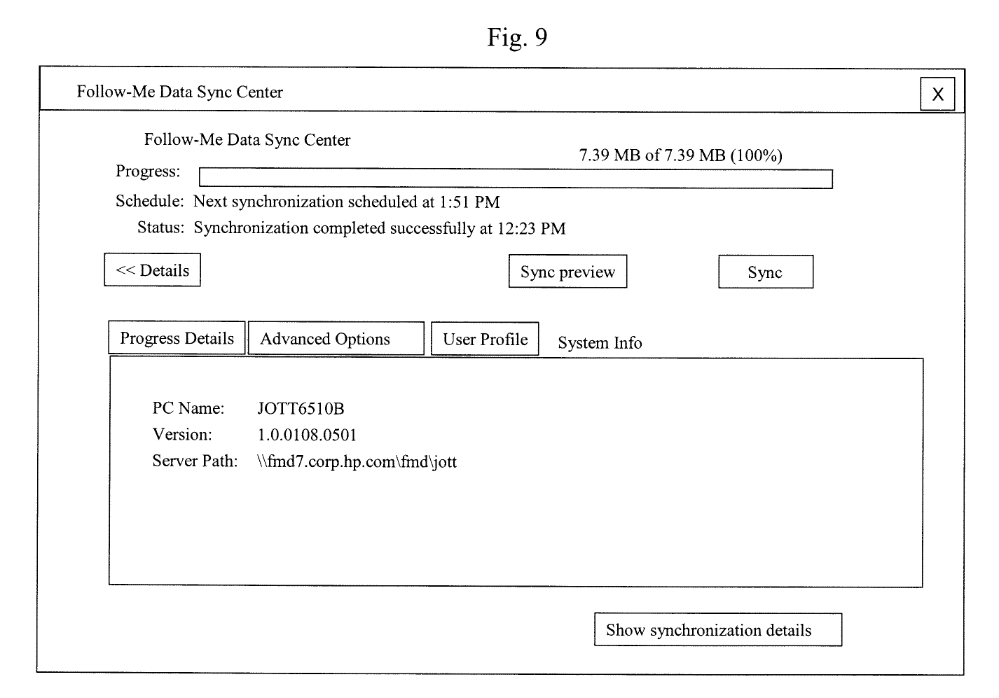

FIG. 9 depicts a screen that shows the system information to the user. In one embodiment, this screen details the PC name, the version of the synchronization system being utilized, and the path to the data repository.

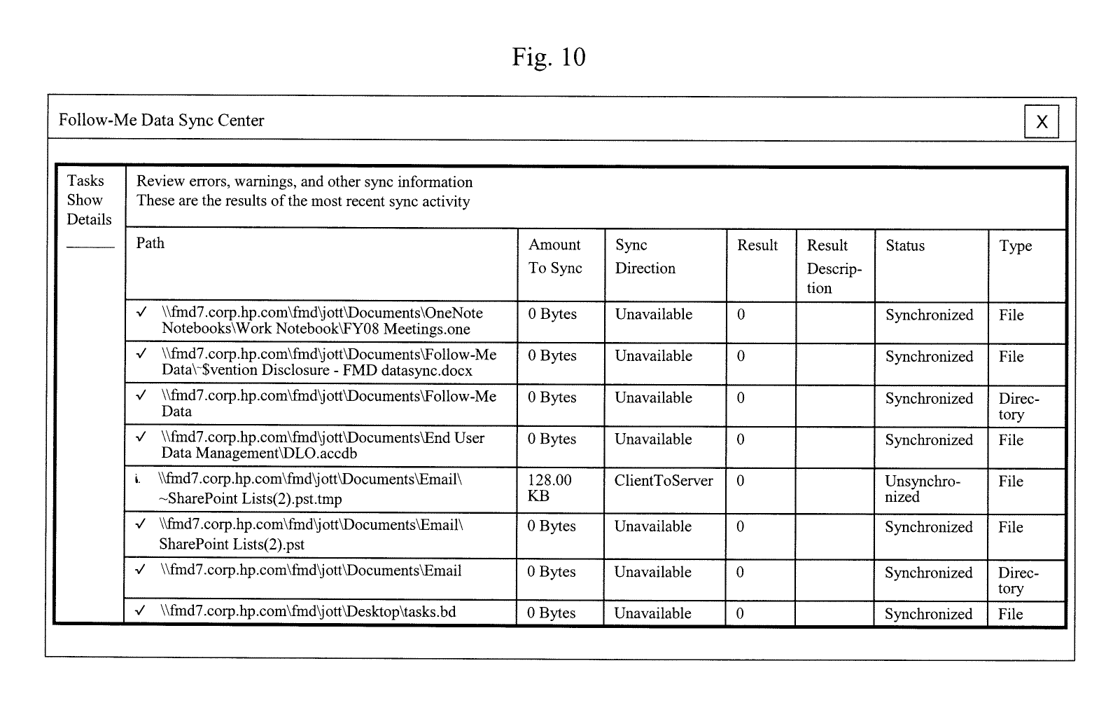

FIG. 10 depicts a screen that details information about the last synchronization completed. In one embodiment, it depicts errors, warnings, and other synchronization information. In a further embodiment, the synchronization process may be able to correct these errors without requiring human intervention. In another further embodiment, the synchronization may prompt the user to correct the errors. It may also show each file or folder, its path, and whether or not the data was properly synchronized for each file or folder. Thus, the user is able to easily view which files were synchronized properly. In one embodiment, this screen may also depict which files have a conflict that needs to be resolved.

In one embodiment, synchronization can be utilized for data recovery. A user can retrieve all of the data last maintained on a local PC from the data repository, in which the data has been stored and synchronized. In one embodiment, all of the data stored in the data repository that corresponds to the user will be restored onto the user's local PC. In another embodiment, the user can select the data to be restored from the data repository. In another embodiment, the user can remove files from being synchronized in the data repository, for example, when the user realizes that the files on the local PC have been corrupted or illegally modified or deleted. In one embodiment, the user can automatically re-image a local PC using the profiles stored during synchronization and the data content from the data repository. Thus, a user can restore a known good software environment with their personal applications, data, and settings. In some embodiments, the user is able to restore his or her local PC without the intervention of outside help, such as a help desk or IT personnel.

In some embodiments, the synchronization presented in this disclosure enables a user to utilize the local files stored on their PC by accessing the corresponding file share in the data repository when accessing a different machine. In one embodiment, the user utilizes their local files on a replacement machine after losing or forgetting their own local PC. In another embodiment, the user accesses their local files on another user's local PC, when working on or near the other user's local PC.

In some embodiments, the synchronization presented in this disclosure improves a Recovery Time Objective, which is the period from when disaster occurs in the local PC to recovery of the process. In some embodiments, the Recovery Point Object is also improved. Recovery Point Objective is the period from the last backup of data until disaster occurrence. Ultimately, this is a measure of data loss tolerance. Utilizing the synchronization presented in this disclosure, a user can retrieve their local data and personal and environment settings after a local disk failure, or a local PC is lost or stolen, or when working remotely or utilizing a different local PC. In one embodiment, synchronization can be utilized to provide local PC replacements to user. Because data is synchronized between the user's previous local PC and the data repository, that data can be utilized to image a new PC or spare PC, with all of the user's most recent local files, user profiles and environment settings.

In one embodiment, synchronization can be utilized for data collection processes. In a further embodiment, data synchronization can be utilized to support electronic discovery of materials for legal matters. For example, when a company or organization is required to submit all of its data in response to a court order, the data stored in the data repository can be submitted. Thus, the company or organization does not have to rely on all of its users or employees to submit their own local files. Instead, the company or organization can obtain the local files that have been stored and synchronized in the data repository.

In one embodiment, the first time synchronization occurs, a custom initialization process is implemented that sets up the local PC for synchronization. For example, the local files are set to be redirected to the specific network share on the data repository. Data is merged so that the backup files in the data repository mirror the local files on the user's local PC. This custom process can be implemented, for example, as a script, batch file and executable. The implementation of this initialization process is not limiting on the invention.

In one embodiment, the custom initialization process includes the following steps. First, a number of checks are complete, and then log files are opened to store information from each synchronization process. The user's local folders are then forced online. For example, a script that utilizes the Win32_OfflineFilesCache WMI class could be run. Next, the top level folders of the user's network share are pinned. For users who have backup data already on their network share, this results in the files and folders in the top level of each of the users shares being present when the initialization process completes and the users starts working. Folders and data below the top level will arrive as the synchronization of data between the client side cache and the network share takes place. In some embodiments, users may be given the choice of which data and how much data they want to synchronize immediately.

Next, the user's folders are redirected, using the WIN32 Shell Class IKnownFolderManager's Redirect method (IKnownFolderManager::Redirect), for example. This method is able to move user data and delete the local folders. In some embodiments, an executable is utilized to implement this method. Pinning and redirecting the folders in separate steps enables better data management and error correction. Further, it allows for more control of what data is copied into the data repository and mergers of that data.

The user is then forced offline. Once the folders have been redirected, the local files on the PC need to be merged with any data the user has on the network share in the data repository. As discussed before, when the local PC is offline, the read and write operations of synchronization are performed against the client side cache. Doing these operations offline, before backing up all of the user's local files to the data repository, is much more efficient than conducting all of the communication across the network. Synchronization of the client side cache and the data repository can then be done in the background after control has been returned to the user.

The next step in the initialization process is to set the attributes of a number of files and folders, to allow them to be deleted. The files, such as desktop.ini, in each of the folders that have been redirected are deleted. These initial files are deleted because the user has two of each file (one initial file and one redirected file that is utilized as the local file that is backed up). Thus, the user deletes the initial file to avoid any conflicts during the initial synchronization of data. These redirected folders and files are considered to be the local files that are synchronized with the backup files in the data repository. Finally, an initial synchronization between the client side cache and the user's network share on the data repository is started.

In one embodiment the local files can be renamed and/or deleted. The corresponding backup files in the data repository are also renamed and/or deleted. Files in the client side cache are also renamed or deleted as appropriate.

The software of the present invention can be implemented in several different ways. The implementation of the software is not limiting on the invention. In one embodiment, the software is installed on a computer readable medium as computer readable code which, when executed, carries out the functionality of the present invention as described herein. In another embodiment, the software is pre-loaded and installed as part of the operating system kernel.

An exemplary system for implementing the overall system or method or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with a variety of programming techniques with rule based logic and other logic to accomplish the various maintaining steps, synchronizing steps, and monitoring steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A system for synchronizing data, comprising:
a user computer configured with a memory that contains at least one local file;
a data repository;
a synchronization component which backs up the at least one local file from the memory to the data repository;
a monitoring component to monitor the synchronization of the at least one local file,
wherein the user computer is configured to initially access the at least one local file from the user computer, and
wherein a backup file in the data repository that corresponds to the at least one local file can be utilized to update the local file.

2. The system of claim 1, wherein the monitoring component comprises a user interface that enables a user to view the status of a synchronization.

3. The system of claim 2, wherein the monitoring component further comprises a scheduling component which allows a user to schedule or initiate a synchronization of the at least one local file and the backup file.

4. The system of claim 2, wherein the monitoring component further comprises a file selection component which enables a user to determine which files are selected for synchronization.

5. The system of claim 1, further comprising a conflict resolution component which enables a user to resolve a conflict in content between the at least one local file and the backup file.

6. The system of claim 1, wherein only a part of the at least one local file that is changed is synchronized with the backup file.

7. A method for synchronizing backup data, comprising the steps of:
maintaining at least one local file on a user computer;
synchronizing electronically the at least one local file on the user computer in a data repository;
monitoring, by a user, the synchronization of the at least one local file,
wherein the user computer is configured to initially access the at least one local file from the user computer, and
wherein a file in the data repository that corresponds to the at least one local file can be utilized to update the local file.

8. The method of claim 7, further comprising enabling the user to view the status of a synchronization on a user interface.

9. The method of claim 8, further comprising enabling electronically a user to schedule or initiate a synchronization of the at least one local file and the backup file.

10. The method of claim 8, further comprising enabling electronically the user to determine which files are selected for synchronization.

11. The method of claim 7, further comprising enabling electronically the user to resolve a conflict in content between the at least one local file and the backup file.

12. The method of claim 7, wherein only a part of the at least one local file that is changed is synchronized with the backup file.

13. A computer readable medium, having embodied thereon computer readable code which when executed, performs a method for synchronizing backup data, comprising the steps of:
maintaining at least one local file on the user computer;
synchronizing the at least one local file on the user computer in a data repository;
monitoring, by a user, the synchronization of the at least one local file,
wherein the user computer is configured to initially access the at least one local file from the user computer, and
wherein a file in the data repository that corresponds to the at least one local file can be utilized to update the local file.

14. The computer readable medium of claim 13, further comprising computer code for providing a user interface that enables the user to view the status of a synchronization.

15. The computer readable medium of claim 14, further comprising computer code for allowing the user to schedule or initiate a synchronization of the at least one local file and the backup file.

16. The computer readable medium of claim 14, further comprising computer code for enabling the user to determine which files are selected for synchronization.

17. The computer readable medium of claim 13, further comprising computer code for enabling the user to resolve a conflict in content between the at least one local file and the backup file.

18. The method of claim 13, further comprising computer code for synchronizing only a part of the at least one local file that is changed with the backup file.
